(19) United States
(12) Patent Application Publication
(10) Pub. No.: US 2019/0075864 A1
(43) Pub. Date: Mar. 14, 2019

(54) INTERACTIVE CLOTHING ITEM WITH CHOREAGRAPHY SYSTEM THROUGH LIGHTING AND AUDIO

(71) Applicant: OSCAR OMAR TORRES SORIA, DELEGACIÓN VENUSTIANO CARRANZA (MX)

(72) Inventor: OSCAR OMAR TORRES SORIA, DELEGACIÓN VENUSTIANO CARRANZA (MX)

(21) Appl. No.: 16/009,152

(22) Filed: Jun. 14, 2018

(30) Foreign Application Priority Data
Sep. 13, 2017 (MX) MX/A/2017/011760

(51) Int. Cl. A41D 27/08; A41D 1/04; A41D 1/00; F21V 33/00; G05B 19/10

(52) U.S. Cl. CPC A41D 27/085; A41D 1/04; A41D 1/005; F21W 2121/06; G05B 19/10; H04R 2201/023; F21V 33/0008

(57) ABSTRACT

The interactive clothing item with lighting and sound system consists of an upper clothing item, integrating at least one processing main board, a sound system interconnected to at least one speaker for sound output, several multicolor lighting means, movement sensors, at least one gyroscopic type, and at least one accelerometer type, on/off snap buttons, and at least one electromagnetic inductive charging device, or charge through a data cable (e.g. USB) in other models. This processing main board uses a wireless communication system, to fulfill the purpose of connecting to a mobile device to acquire songs from the digital library, creating its own choreographies, sharing results, statistics and errors with the developers, and connecting to other interactive clothing items to perform group competitions, etc. Several multicolor lights are preferably installed in the cuffs, on the front and at chest height, of the interactive clothing item. These lights can be turned on in at least five colors.

### CROSS REFERENCE TO RELATED APPLICATIONS

This disclosure claims the priority of Mexico patent application No. Mx/a/2017/011760, filed on Sep. 13, 2017, and the entire contents thereof are incorporated herein by reference.

### INVENTION FIELD

The invention herein is related to the recreation industry and sports in general. It is an interactive clothing item used to perform dancing routines, and it is specifically related to an upper clothing item with at least, one electronic device emitting lights and audible instructions to direct choreographies while sensing the movements. It is wireless connected to other electronic devices of the same kind and mobile devices (e.g. Smartphones) to perform functions other than its main function.

### INVENTION BACKGROUND

Recreation is usually related to the performance of an amusing activity, something we can do on our own, or with others, to be entertained or amused during our free time, or something that makes us relaxed or laugh. Recreation has many kinds of activities that have become usual, from reading books to visiting museums, and historical places, or playing sports, or traveling across the globe.

Recreation, particularly dancing, has been a pillar of sports throughout history, and it has evolved technologically, becoming more innovative.

There are many application examples illustrating how recreation is being transformed into something more innovative. For example, interactivity is progressively spreading across all entertainment objects, including toys, devices and clothing items [e.g. Heelys®*].

Moreover, dancing is considered an activity that boosts expressive abilities, cognitive skills and an optimal emotional status. In addition to being considered an art, dancing is also an activity that entails comprehensive benefits at any age, being particularly beneficial for children.

Dancing stimulates perceptive and physical-motor qualities, which allows children to recognize their body, the space around them, and the time in which they are moving, developing laterality, that is, distinction between left and right.

It also develops their sense of rhythm, as well as their creativity, improving the body posture and promoting an optimal physical health. In addition to developing these qualities, the activities performed within the dancing field provide more flexibility, agility, resistance and strength, as well as a greater balance control.

Dancing games are usually dynamics about following the music rhythm and performed individually, in couples, or as group, and usually tighten the bond between the participants. In general, these activities are performed in closed or open venues, on the occasion of a celebration or a competition. In these events, dancing routines must be followed, which were taught by the instructor of each team, and a series of rules set by the entertainer.

Furthermore, among the products used for the development of skills or abilities related to this invention currently offered in the market, we can find those entailing movements through instructions and colors, such as Twister® and Twister Hip Hop®. An additional type of products are the electronic devices incorporating instructions and sounds, such as Bop It®. Some other involve memorizing a sequence of colors and sounds, such as the following products: Simón®, Simón Air® and Colorflash®. There are electronic devices involving movements and dancing through instructions and colors, such as the following products: Twister Dance® and Twister Moves®.

The aforementioned games help developing physical-motor skills, sociability skills, memory and creativity, among others. This invention counts on all these advantages, and it is a product new in the market, consisting in a upper clothing item that allows the performance of choreographies, following the instructions indicated through sounds and lights which change their colors to instruct a movement and indicate whether was right performed. Performing successfully the choreographies allows to advance across the game difficulty levels and songs.

Additionally, several jackets can be wirelessly connected, to perform group choreography competitions. The musical content can be updated and customized through a mobile device and web.

In addition, there is a wide variety of dancing videogames in the market, which are interactive, such as music rhythm games, where the player controls a dancing avatar through the user interface, or actually dancing on a specialized controller recording the moves, or using movement sensors to record the users' movements in a screen, such as Kinect Dance Central®, Nickelodeon Dance®, Zumba Kids® and Just Dance Kids®. In addition, we can find the following routine memorizing games: Osu!®, Elite Beat Agents®, etc. Other games using dancing platforms: Dance Dance Revolution®, Dance Central® and Just Dance®.

Due to the wide use of electronic devices for entertainment (videogames, smartphones, etc.), inactivity has increased among children with access to this type of products, increasing the rate of diseases related to isolation (e.g. low self-esteem, bullying, etc.) sedentary lifestyle, and bad eating habits, usually lifelong afflictions. Likewise, and even though some specialists will not categorize the compulsive use of videogames as an addiction, there are several addiction centers across the globe, treating people considered addicted to videogames.

On the other hand, this invention provides an advantage over the use of videogames for dancing, such as the fact that it is less expensive, it widely favors sociability and real interpersonal play and thanks to the technology used, it can be used indoors and outdoors. An additional advantage in relation to videogames, it is that allows the user wear the invention and be protected from elements because it is Clothing, an essential item for life.

In addition, it can also be used for other purposes, such as fitness lessons without an instructor, set up your own choreographies, flashmob, among others.

Additional uses of this invention, which make us feel very optimistic, are diversion, therapy, exercise and inclusion for disabled people (e.g. people on wheelchairs, the deaf, the blind, people with Down's Syndrome, people in rehabilitation, and the elderly, etc.), since it is a motivating challenge to progress onto more complex levels, it does not require an instructor, it is easily worn, and it can be used even on a hospital bed.

In the state of the art study, a search was performed in order to identify the closest state of the art, regarding this invention. The patent with international number PCT/US19951002887 was found, internationally submitted on Mar. 7, 1995: “Synthesized music, sounds and lights system”, held by Marcello S. Drago; which entails a synthesized music, sounds and lights system, built in clothing items, such as shoes. When the system is activated, it allows multiple lights to go off, synchronized with an internal or external music or sound program, heard through an audio transducer.

When the system is built in a pair of shoes, a person can perform a dancing routine, or another form of expression, along with the music selected and the lights program. The system includes three controls operated by the user, a music selection switch, allowing the selection of musical lighting programs, a light speed control, and the rhythmic pulse of the selected program, and a control to adjust the sound volume.

An additional patent with international application number PCT/US20061035983 was found, internationally submitted on Sep. 13, 2006: “Illuminated clothing item, sensitive to movement”, held by E. S. ORIGINALS, INC; which involves an illuminated clothing item with bright lights that respond to the user's movements, which is also waterproof.

Likewise, patent with application number PA/a/2000/001677 was found, submitted on Feb. 17, 2000, “Color lights projection system through fiber optics for clothing items, and other objects”, held by Luis Guillermo Garibay González; which involves a color lights projection system through fiber optics for any kind of clothing item, including shoes and several objects, and the like, for advertising or decoration purposes, which consists of a small electronic tablet with components such as built-in circuits, light-emitting diodes, sending light through fiber optics to the outer part of the object, projecting colors and movement, using batteries as a power source, allowing the system to be an effective lighting portable system.

Patent number US2017200351 was also found, published on Jul. 13, 2007, “Sound-Producing Shoe Including Impact and Proximity Detections” held by Grubba Robert; which entails an audio-optical shoe with light and sound projection effects, in the shoe field. It is characterized by containing, in the back middle part of the sole, a set of sensors, a controller, a battery box, a charge controller, and charging antenna by induction in the lower part of the right shoe, the battery box contains one battery, the charge controller, and it is locked with a sealing screw, and the shoe sole. A light-emitting diode, a rotation entry device, and a charge entry port are arranged in appropriate positions in the lateral wall of the sole. The multiple sensors, the rotation entry device, the light-emitting diode, the speaker and the battery are respectively connected to the controller, the charge controller is connected to the charge antenna by induction, and the charge port. This invention has several applications, other than the entertainment sound effect and decorations for the young users, it is useful for dancing teaching, and it allows the users to improve the training level.

Patent number CN104808798 was also found, dated Sep. 29, 2015, “Kinect-based multi-screen interactive folk-dance entertainment system”, held by HARBIN INST OF TECHNOLOGY; which entails a Kinect-based interactive popular dancing entertainment system, belonging to the technical field of Kinect-based folk dance somatosensory game systems, and the objective is solving the problem of the existing dancing game, lacking immersion, and a proposal of popular dancing game. It protects a main projector, a third projector, and a fourth projector of the interactive popular dancing entertainment system, with several Kinect screens, arranged in the center of a square sequentially formed around the main screen, a second screen, a third screen, and a fourth screen. The Kinect equipment is arranged under the front surface of the main screen, one sound box, and a second sound box arranged in the two edges of the third screen, respectively. The data output end of the Kinect equipment is connected to the data entry end of a central computer. The Kinect somatosensory equipment includes Chinese classic popular dancing, through recognized actions, determining a relevant method, a user can obtain accurate-action feedback through projections in multiple screens. The user can obtain a wholeheartedly immersion experience.

As shown above, the aforementioned documents apply processes and objectives different to the ones applied by this invention, none of the previous documents reveals an interactive clothing item that can be wirelessly connected to other interactive clothing items, including a light and sound set, indicating choreographies that the user must follow, incorporating at least one processing main board, with at least one gyro-accelerometer to sense the movements, at least one interconnected audio system, with a speaker for sound output (music, dancing instructions, motivations, and option menu), on/off snap buttons, several LED in multiple colors, preferably arranged on the sleeves ends, on the front at the chest of the clothing item. At least one processing main board comprises a rechargeable power source, through a electromagnetic inductive charging device or through a data cable (e.g. USB) in a different model; and a wireless communication device to communicate to other electronic devices of the same kind and also, to mobile devices (e.g. Smartphones) to perform functions other than its main function.

### Invention Objectives

The invention herein has the main objective to make an interactive clothing item, with lighting and sound system available, allowing the performance of dancing choreographies, by following the instructions indicated through audio and lights which change their colors to instruct a movement and indicate whether was right performed. Performing successfully the choreographies allows to progress through several game difficulty levels, and songs.

An additional objective of the invention herein is for this interactive clothing item with a lighting and sound system to enhance the physical and motor skills of the users, encouraging them to exercise, improve their nutrition and avoid inactivity.

An additional objective of the invention herein is for the interactive clothing item with a lighting and sound system to cover an essential need, such as clothing and, at the same time, becoming a healthy and fun form of recreation.

An additional objective of the invention herein is for the interactive clothing item with a lighting and sound system to be used for individual or group competitions.

An additional objective of the invention herein is for the interactive clothing item with a lighting and sound system to be wirelessly connected to several interactive clothing items to perform group competitions.

An additional objective of the invention herein is for the interactive clothing item with a lighting and sound system to count on an instructions manual on paper, and an additional interactive manual during the first dance, to make the invention more easy to use.

An additional objective of the invention herein is allowing the incorporation of the interactive system into this clothing item to play songs for the choreographies and several motivational quotes to encourage children to be better human beings.

An additional objective of the invention herein is allowing the software of this interactive clothing item with a lighting and sound system to be updated and customized through wireless synchronization through a mobile device and through a data cable (e.g. USB) via web.

An additional objective of the invention herein is allowing this interactive clothing item with a lighting and sound system to connect to a mobile device, to acquire songs from a digital library, create its own choreographies, control the device, share results, statistics and errors with the developers, etc.

An additional objective of the invention herein is allowing this interactive clothing item with a lighting and sound system to contain at last one speaker for sound output (music, instructions, etc.).

An additional objective of the invention herein is allowing this interactive clothing item with a lighting and sound system to contain lighting means that can be turned on in, at least, five colors (green, yellow, red, blue and white).

An additional objective of the invention herein is to allow this interactive clothing item with a lighting and sound system to contain gyro-accelerometers movement sensors, preferably installed in the cuffs and back of the clothing item.

An additional objective of the invention herein is to allow this interactive clothing item with a lighting and sound system to contain on/off snap buttons. The invention also allows to perform some movements to completely control the item like raise a hand up to select a song from the menu, turning left or right to go forward/backwards between songs and change language, squat to cancel, etc.

An additional objective of the invention herein is for this interactive clothing item with a lighting and sound system to use a electromagnetic inductive charging device activated by placing the collar of the item on a rack provided for such purpose, or through a data cable (e.g. USB) in different models.

An additional objective of the invention herein is to allow this interactive clothing item with a lighting and sound system to notify the level of battery charge, by reducing or increasing the intensity of the lights, and the volume, of the device, according to the charge level.

An additional objective of the invention herein is to allow this interactive clothing item with a lighting and sound system to be ergonomic, in order to dance with comfort, considering low weight and the dimensions of the device used.

An additional objective of the invention herein is to allow this interactive clothing item with a lighting and sound system to have the battery and processing main board inside a fire-and-leaking proof safety case which is also removable to wash the clothing item.

An additional objective of the invention herein is to allow the design of this interactive clothing item with a lighting and sound system to vary regarding the arrangement of components, design and raw materials for aesthetics, add new functionalities and ergonomics purposes.

All these qualities and objectives will become evident when making a general and detailed description of this invention, supported by the illustrated modalities.

### BRIEF INVENTION DESCRIPTION

In general, the interactive clothing item with lighting and sound system, according to the invention herein, consists of an upper clothing item, integrating at least one processing main board, a sound system interconnected to at least one speaker for sound output (music, instructions, etc.), several multicolor lighting means, gyro-accelerometers movement sensors, on/off snap buttons, and at least one electromagnetic inductive charging device, or charge through a data cable (e.g. USB) in different models.

At least one processing main board is preferably installed on the back of the item, using a wireless communication system to fulfill the objective of connecting to a mobile device to acquire songs from the digital library, its own choreographies, sharing results-statistics and errors with the developers, and connecting to other interactive clothing items to perform group competitions, etc.

Several multicolor lighting means are preferably installed in the cuffs of the sleeves and in the front portion, at the chest area of the interactive clothing item. These lighting means can display at least five colors (green, yellow, red, blue, white and others). Regarding the movement sensors used in this invention, these are preferably installed in the sleeves cuffs and in the back, at least one of them used as a gyroscope, and at least one being used as a accelerometer.

This on/off snap system button is preferably installed in the right cuff. Another snap button is preferably installed in the left cuff to turn the wireless communication system on and off, when snapped together as any button. Likewise, this electromagnetic inductive charging device is preferably installed in the back part of the collar of the clothing item, recharging is done through the use of a rack provided for this purpose, or for other models, in this same position, a data cable is found (e.g. USB), which can be connected to any data plug for recharging.

This upper clothing item has a variety of options to choose from: a jacket, a shirt, a blouse, a T-shirt, a coat, a robe, or the like, with long sleeves. Likewise, the arrangement of the components comprised in the interactive clothing items can be adapted, to carry out its functions.

The general functioning of this interactive clothing item with lighting and sound system is described below: The clothing item is placed on the top part of the body, just as any other upper clothing item. To turn on the device, the snap button on the right cuff, is snapped together, and then the preferred language it is selected by turning left or right, then some welcome words are emitted, and the lighting means are turned on in blue. To turn off the device, the snap right button is unplugged and some goodbye words are heard, and the lighting means are turned on in blue, and the lights start to dim, until fully turned off. The device will notify when there is only 10% of battery left, and the functioning of the device will be decreased, with the highest volume at 50%, and dimming the brightness of the lights. To recharge the battery, the collar must be placed on the rack provided for this purpose, and the lighting means will turn on in yellow, and dimming until the lights are off, to notify the charge has been completed, the lighting means will turn on in green. In other models, it must be directly connected through a data plug (e.g. USB), with the same set of charge lights set and locations explained above.

The individual choreography general functioning of this interactive clothing item with lighting and sound system is described below: After being turned on language can be selected by turning to left o right (Spanish and English), then the welcoming is played and the song catalogue is presented to select a song. The user can fast-forward or fast-backward the songs in the menu by turning to the right or to the left. Auditive signals will indicate the name of the song, the artist and the level of difficulty of the choreography, and the lighting means will be turned on as follows, according to the difficulty level of the choreography to perform: green for easy, yellow for medium, and red for hard. To select a song, the right hand must be lifted up waving it from one side to the other, and the audible instructions will mention the name of the songs and the cuff lights will be turned on in blue. The audio will notify that dancing is about to start, to be ready, through a countdown, and the lights will be fully turned off. Next, the song will start, and the choreography indicated through audio and lights must be followed. If a movement is performed correctly, the lights will be briefly turned on in green, if a certain movement is not performed correctly, the lights will be briefly turned on in red, if there is 50% of error, the song will be suspended, the voice will motivate the user, and the lights will turn on in red, dimming until they are out. The same song will be automatically restarted for another chance, and the countdown will start over, and the lights will be fully out to start the song again, and the choreography must be followed as indicated by the voice and the lights, if the song is completed with less than 50% of error, the voice will congratulate the user with a motivational quote, while the lights will turn on in green, dimming until completely out. The selection of the following song will start again by lifting the right hand up waving it from one side to the other.

The group choreography general functioning of this interactive clothing item with lighting and sound system is described below: To start searching for other interactive clothing items, the snap button on the left cuff must be snapped together, and the voice will notify the search for friends is started, and the lights will turn on in blue intermittently. If no device is found in 30 seconds, the voice will notify the confirmation of no close friends, while the lights will turn off completely, and the song menu will be started, to start an individual choreography. If a device is found, they will be automatically connected, while the audio will notify the confirmation of a friend connected, and the lights will turn on in white. The search will continue for 10 seconds after the last device connected, while the lights of the connected interactive clothing items will remain in white. After connecting, a song catalogue is displayed, to choose one song. Once the song is chosen, the group choreography must be followed, through audio notifications and the respective lights, as described for the individual choreography. At the end of the song, all the users will be congratulated with a motivational quote, and the clothing item of the person with the least mistakes will turn on in white; in case of a tie, the tied items will be turned on. To exit the group, unplug the snap button, and the voice will notify the confirmation of group choreography is off, while the lights turn on in intermittent blue.

The update software general functioning of this interactive clothing item with lighting and sound system is described below: For the update of the software, the device must be synchronized wirelessly with a mobile device or plugged via USB to a computer. For wireless software update, after turning on the clothing item, automatically it searches out for its mobile device to pair, the latter confirms the connection an triggers the update from an app. To first pair, the clothing item must selected on the bluetooth settings of the mobile device. Via USB just need to be plugged and set up on a web page. For both scenarios it is updated: the new acquired songs, the creation of choreographies, name settings, sharing results-statistics and sharing errors with the developer, etc.

The general functioning of movements of this interactive clothing item with lighting and sound system is described below: The instructions will be indicated through audio and lights, as mentioned before, the lights are installed in the cuffs of both sleeves and at the front, at chest height of the interactive clothing item with lighting and sound means. To lift both hands up, the audio will notify “up”, while the lights on the right sleeve will be turned on. To move both hands up, waving them from side to side, the audio will notify “wiggle”, while the lights on both sleeves are turned on intermittently. To bring both hands down, the audio will notify “down”, while the lights on both sleeves will be turned on.

To turn to the right, the voice will say “right”, while the lighting means at the chest's right side are turned on. To turn to the left, the voice will say “left”, while the light in the chest's left side are turned on.

To jump to the front, the audio will notify “forward”, while lights on both lower front area, at chest height, are turned on. To jump to the back, the audio will notify “backward”, while the upper front of both lights, at chest height, are turned on.

To jump, the voice will notify “jump”, while the lights on both upper sides, at chest height, are turned on intermittently. To squat, the voice will notify “squat”, while the lights on both lower sides, at chest height, are turned on intermittently.

To randomly move the whole body, the voice will say “crazy”, while all the lights are turned on at a high speed intermittently.

To better understand the invention characteristics, the following illustrative, but not limiting, drawings are included in this description, which are fully described below the preferred modality.

### BRIEF DESCRIPTION OF FIGURES

FIG. 1 shows a view of the interactive clothing item with lighting and sound system and its components.

FIGS. 2 to 11 show schematic diagrams of all the movement instructions regarding the activation of the lighting means, and the voice instructions.

To better understand the invention, a detailed description of some of its modalities is found below, shown through the illustrative, but not limiting drawings attached to the description herein.

### DETAILED DESCRIPTION OF THE INVENTION

The characteristic details of the interactive clothing item with lighting and sound system are clearly shown through the following description and the illustrative drawings attached, with the same reference signs to point out the same parts.

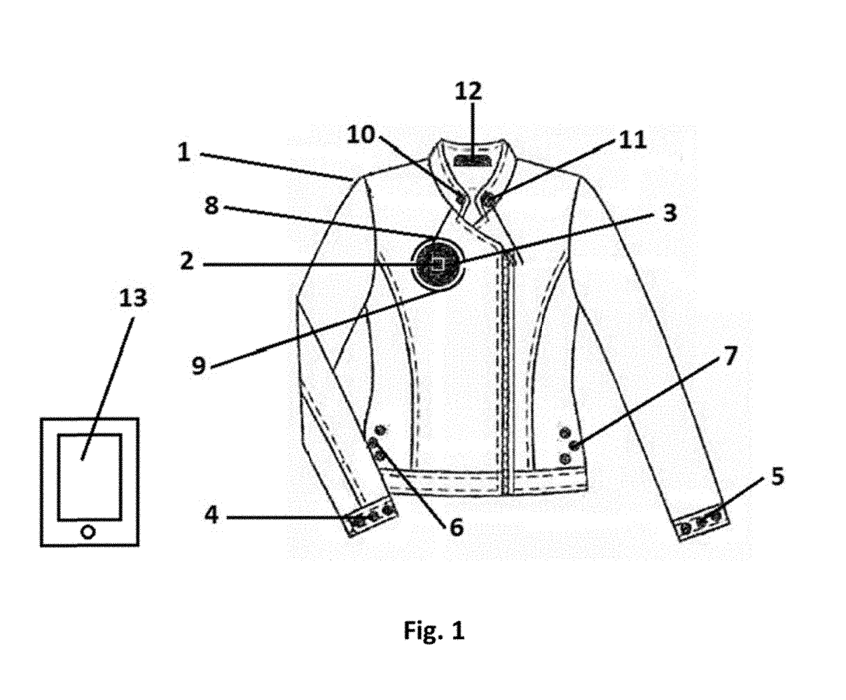

FIG. 1 shows a view of the interactive clothing item with lighting and sound system, showing an upper clothing item integrating at least one processing main board 2, an interconnected audio system to at least one speaker 3 for the sound output (music, instructions, etc.), several multicolor lights 4, movement sensors as a gyro-accelerometer 5, a system on/off snap button and a wireless on/off snap button 6, and at least one electromagnetic inductive charging device or for other models a data plug (e.g. USB) 7. A rechargeable LiPo battery 8 and a safety case 9.

At least one processing main board 2 is preferably installed on the back of the item, using a wireless communication system, to fulfill the objective (additional to the main function) of connecting to a mobile device to acquire songs from the digital library, its own choreographies, sharing results-statistics and errors with the developers, and connecting to other interactive clothing items to perform group competitions, etc.

Such processing main board generates the on/off instructions for the multicolor lighting means 4, the playback of songs, and the execution of voice instructions.

Several lights 4 are preferably installed in the cuffs, right and left respectively, and other lighting means are arranged in the front area, at chest height, on the lower and upper area, respectively, preferably around the speakers 3 of the interactive clothing item. These multicolor lighting means 4, can be turned on in at least five colors (green, yellow, red, blue, white and others); regarding the movement sensors 5 used in this invention, these are preferably installed in the cuffs and in the back, or in any other area of the clothing item, which are at least one gyroscope type, and one accelerometer type.

This system on/off snap button is preferably installed in the right cuff of the interactive clothing item. The wireless button 6 is used to turn on/off the wireless communication system, and it is preferably installed in the left cuff of the clothing item. Such electromagnetic inductive charging device 7 is preferably installed inside the back part of the collar of the clothing item. Recharging is performed through a rack (not shown) used for this purpose. In other models, it must be directly connected through a data plug (e.g. USB) with the same location.

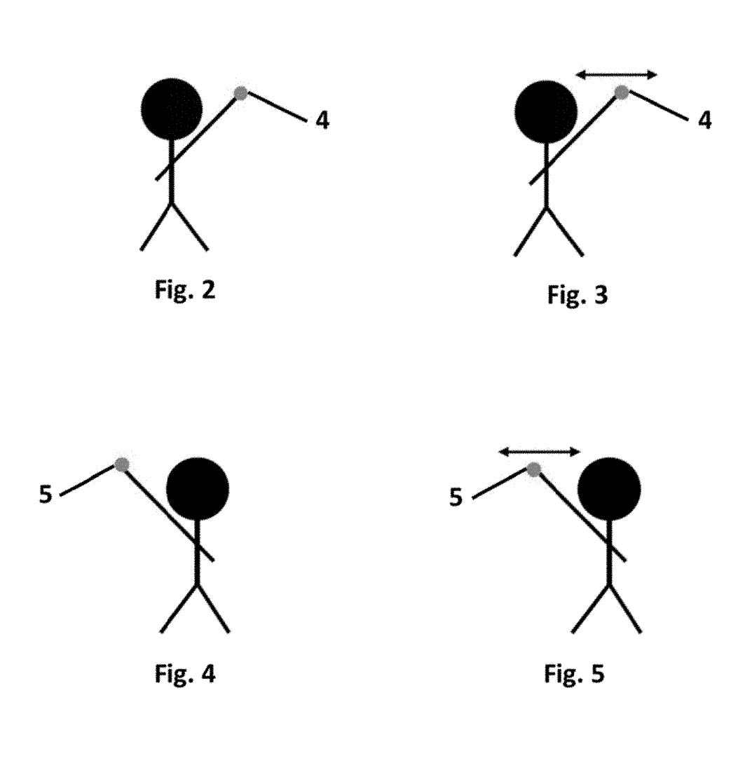

Regarding FIG. 2, it shows a schematic diagram of the interactive clothing item with light and sound system, showing the execution of the visual movement instruction to raise both hands up, while the audible instruction indicates “up”, while all the lights on the cuff of both sleeves 4 are turned on in yellow to perform the movement, and then, in green, if performed correctly, or red, if performed incorrectly.

Regarding FIG. 3, it shows a schematic diagram of the interactive clothing item with light and sound system, showing the execution of the visual movement instruction to raise both hands and waving from one side to the other, while the audible instruction indicates “wiggle”, while all the lights on the cuff of both sleeves 4 are turned on in yellow intermittently to perform the movement, and then, in green, if performed correctly, or red, if performed incorrectly. Regarding FIG. 4, it shows a schematic diagram of the interactive clothing item with light and sound system, showing the execution of the visual movement instruction to bring both hands down, while the audible instruction indicates “down”, while all the lights on the cuff of both sleeves 4 are turned on in yellow to perform the movement, and then, in green, if performed correctly, or red, if performed incorrectly.

Regarding FIG. 5, it shows a schematic diagram of the interactive clothing item with light and sound system, showing the execution of the visual movement instruction to turn to the right, while the audible instruction indicates “right”, while all the lights on the right side, at chest's height, 4 are turned on in yellow to perform the movement, and then, in green, if performed correctly, or red, if performed incorrectly.

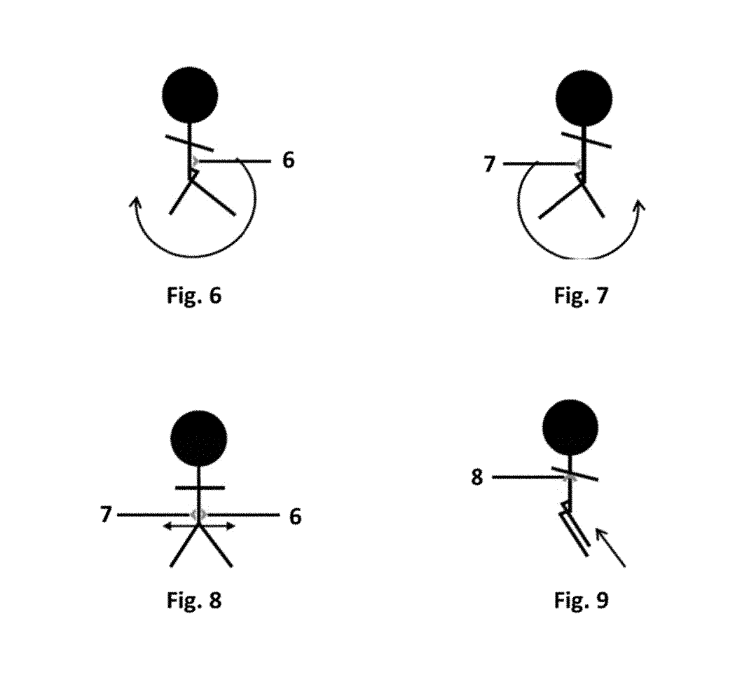

Regarding FIG. 6, it shows a schematic diagram of the interactive clothing item with light and sound system, showing the execution of the visual movement instruction to turn to the left, while the audible instruction indicates “left”, while all the lights on the left side, at chest's height, 4 are turned on in yellow to perform the movement, and then, in green, if performed correctly, or red, if performed incorrectly.

Regarding FIG. 7, it shows a schematic diagram of the interactive clothing item with light and sound system, showing the execution of the visual movement instruction to jump to the front, while the audible instruction indicates “forward”, while all the lights on the front lower area, at both chest height, are turned on in yellow to perform the movement, and then, in green, if performed correctly, or red, if performed incorrectly.

Regarding FIG. 8, it shows a schematic diagram of the interactive clothing item with light and sound system, showing the execution of the visual movement instruction to jump to the back, while the audible instruction indicates “backwards”, while all the lights on the front upper area, at both chest height, are turned on in yellow to perform the movement, and then, in green, if performed correctly, or red, if performed incorrectly.

Regarding FIG. 9, it shows a schematic diagram of the interactive clothing item with light and sound system, showing the execution of the visual movement instruction to jump, while the audible instruction indicates “jump”, while all the lights on the upper area, at both chest's height, are turned on intermittently in yellow to perform the movement, and then, in green, if performed correctly, or red, if performed incorrectly.

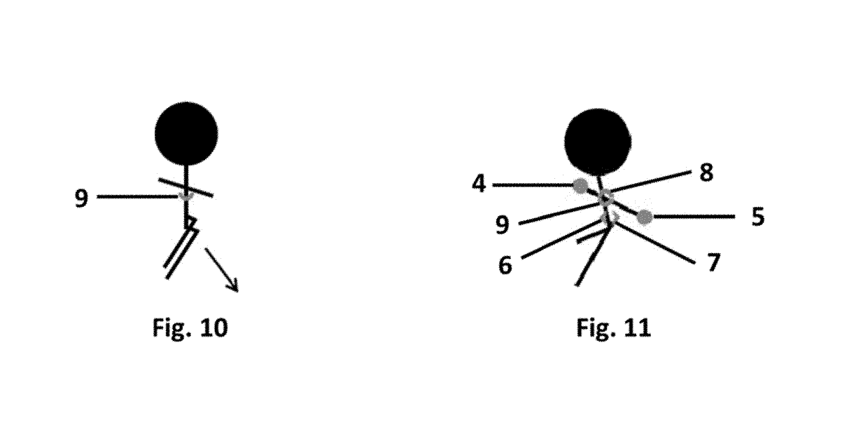

Regarding FIG. 10, it shows a schematic diagram of the interactive clothing item with light and sound system, showing the execution of the visual movement instruction to squat, while the audible instruction indicates “squat”, while all the lights on front lower area 4 at both chest's height, are turned on intermittently in yellow to perform the movement, and then, in green, if performed correctly, or red, if performed incorrectly.

Regarding FIG. 11, it shows a schematic diagram of the interactive clothing item with light and sound system, showing the execution of the visual movement instruction to randomly move the whole body, while the audible instruction indicates “crazy”, while all the lights 4 are intermittently turned on, at a high speed, in yellow to perform the movement, and then, in green, if performed correctly, or red, if performed incorrectly.

The invention has been described enough for a person with medium knowledge on the field to reproduce and obtain the results mentioned in the invention herein.

Nevertheless, any person with skills in the technical field related to this invention is able to make adjustments that have not been described in the request herein. Nevertheless, if the application of these adjustments on a certain structure or the manufacturing process thereof, the matters stated in the following claims are required, such structures must be included within the scope of the invention.

Having described the invention enough, the contents in the following claims are claimed as proprietary:

1. An interactive clothing item with lights and a sound system used to perform choreographies individually or in groups, characterized by being an upper clothing item integrating at least one processing main board, at least one audio system interconnected to at least one speaker for sound output, several lighting means arranged in both cuffs, in the upper front portion, at chest height, around the speaker, or arranged in other portions of the item; movement sensors such as gyro-accelerometers and system on/off snap button. The processing main board generates the on/off instructions of these lights, the execution of voice instructions, the playback of sounds-tracks, and it includes a wireless communication system to connect to other similar interactive clothing items, and at least one mobile device for functions other than the main function.

2. The interactive clothing item with light and sound system, according to claim 1, characterized by comprising on/off snap buttons which is used to turn the wireless on and off when snapped together, and at least one electromagnetic inductive power charging device, or another type of charge, preferably installed inside the back portion of the collar of the clothing item, and in other models, it is charged through a data cable (e.g. USB).

3. The interactive clothing item with light and sound system, according to claim 1, characterized by having processing main board preferably installed on the back of the item, hidden inside a fire-and-leaking proof safety case alongside the battery, using a wireless communication system, to connect to a mobile device to acquire songs from the digital library, creating its own choreographies, sharing results-statistics and errors with the developers, and connecting to other interactive clothing items to perform group competitions, etc.

4. The interactive clothing item with light and sound system, according to claim 1, characterized by having movement sensors preferably installed in the cuffs and the back, or other sections of the clothing item.

5. The interactive clothing item with light and sound system, according to claim 4, characterized by such movement sensors comprising at least one gyroscope, and at least one accelerometer.

6. The interactive clothing item with light and sound system, according to claim 1, characterized by several multicolor lighting means being LEDs in colors such as green, yellow, red, blue, white, or others.

7. The interactive clothing item with light and sound system, according to claim 1, characterized by such on/off snap button being preferably installed in both cuffs of the interactive clothing item.

8. The interactive clothing item with light and sound system, according to all claims above, characterized by being an upper clothing item, which could be a jacket, a shirt, a blouse, a T-shirt, a coat, a robe, or the like, with long sleeves.

9. The interactive clothing item with light and sound system, according to claim 1, 2, 3, 4, 5, 6, 7 and 8, characterized by such components to allow perform choreographies, instructing the movements through audio and lighting while playing sound-tracks, and sensing the movement to indicate it whether were right performed or not.
